(19) United States
(12) Patent Application Publication
(10) Pub. No.: US 2009/0214803 A1
(43) Pub. Date: Aug. 27, 2009

(54) Artificial Stone

(75) Inventors: Lisa Huber, Chanhassen, MN (US); Richard P. Ranieri, East Northport, NY (US); Pedro Delantar, JR., Las Vegas, NV (US)

Correspondence Address: FISH & RICHARDSON P.C., PO BOX 1022, MINNEAPOLIS, MN, 55440-1022, US

(73) Assignee: Huber Marketing Group, LLC, Chanhassen, MN (US)

(21) Appl. No.: 12/209,896

(22) Filed: Sep. 12, 2008

Related U.S. Application Data
(60) Provisional application No. 60/971,876, filed on Sep. 12, 2007.

(51) Int. Cl. B44F 9/04; B44F 7/00

(52) U.S. Cl. 428/15

(57) ABSTRACT

Artificial stones and rocks are disclosed including methods of making same.

### CROSS REFERENCE TO RELATED APPLICATIONS

This application claims priority under 35 U.S.C. §119(e) of U.S. Application No. 60/971,876, filed Sep. 12, 2007 by Huber et al. and entitled “Articial Stone,” which is incorporated in its entirety herein by reference.

### SUMMARY

An imitation stone may, in certain embodiments, comprise a portion of real, earthly matter, combined with a binding agent, and have visual and tactile properties that closely match those properties of authentic stones and rocks found in nature. In selected embodiments, the binder comprises a colorant to provide a realistic representation of a naturally occurring rock or stone color. In selected embodiments the real, earthly matter includes limestone, and further, the limestone may be in crushed or uncrushed form. In some selected embodiments the imitation stone can include a mechanism for securing the imitation stone to a selected location. In some selected embodiments the mechanism for securing the imitation stone to a specific location is a stake, having a threaded end that can be inserted into a threaded collar housed in a portion of the imitation stone. The stake may then be inserting into the earth, thereby holding the imitation stone in place.

The details of one or more embodiments are set forth in the accompanying drawings and the description below. Other features, objects, and advantages will be apparent from the description and drawings, and from the claims.

### DESCRIPTION OF DRAWINGS

FIG. 1 is a cross-sectional view of an artificial stone.

FIG. 1A is a photograph of an artificial stone and a mechanism for securing the artificial stone to an anchor point, according to one embodiment

FIG. 2 is a photograph of a collection of artificial rocks.

FIGS. 3A and 3B illustrate a method of transporting a collection of artificial stones, according to one embodiment.

### DETAILED DESCRIPTION OF ILLUSTRATIVE EMBODIMENTS

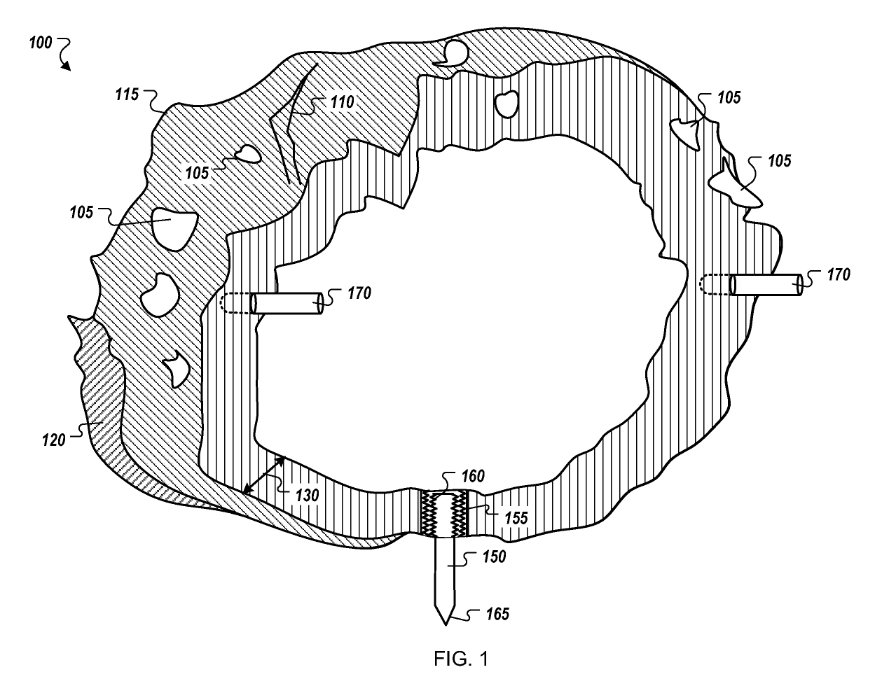

FIG. 1 is a cross-sectional view of an artificial stone 100 according to one embodiment. The artificial stone 100 has features on the exterior closely resembling, if not directly matching those that can be found on naturally-occurring rocks and stones found in nature. Examples of the features that can additively combine to create a level of realism include stone fragments 105, fissures 110, surface 115 texture, contour, and color, and regions, e.g., region 120 that differ in the aforementioned properties from its immediate surroundings.

In some embodiments, stone fragments 105 can be comprised of various types of real rock. In some embodiments, stone fragments 105 are of the same type of rock, but are present in varying shapes and sizes to produce the look of a larger rock or stone that may be found in nature.

In some embodiments, the artificial stone 100 is hollow. In some embodiments, the artificial stone 100 can be comprised of a mixture that includes earthly matter, for example, real stones, rocks, or minerals, and a binding agent that holds the composition together in solid form. In some embodiments, the mixture can include real stones, rocks, and minerals that have been crushed or pulverized, for example, crushed limestone. The binding agent can include compounds such as resins, glues, polymers, and cement mixtures, for example, that can be mixed together with the earthly matter and bind them together to produce a solid form. A process is disclosed in U.S. patent application Ser. No. 10/250,153, and is incorporated in its entirety herein by reference.

In some embodiments, a resin can be mixed with crushed rock or aggregate to produce a moldable admixture. In some embodiments, a resin can comprise polyester resin, and in these embodiments, the polyester resin may include polyester resin auxiliaries. In some embodiments the polyester resin auxiliaries can comprise a styrene monomer, an accelerator and a catalyst (or “hardener”). In some embodiments the styrene monomer can be present in the range of 5% to 30% by resin weight, for example, from 10% to 20% by weight, from 7.5% to 15% by weight, however, more or less styrene monomer can be used. In some embodiments the accelerator can include cobalt octoate. Cobalt octoate can be preferentially present in the polymer resin in the range of 0.2%-0.5% per resin weight, for example, 0.28% to 0.32% per resin weight, 0.25% to 0.35% per resin weight, 0.23-0.47% per resin weight, however, more or less of the cobalt compound can be used. In some embodiments, dimethyl aniline can be used as an accelerator using preferentially 0.1%-0.2% by resin weight, for example, 0.14%-0.16% by resin weight, 0.12% to 0.18% per resin weight, however, higher or lower concentrations may be used. In some embodiments, polymer methyl ethyl ketone peroxide (MEKP) can be used as the catalyst (or hardener). When MEKP is used, it can preferentially be present in the polyester resin between 1%-3% by resin weight, for example, 2.8% to 3.2% by resin weight, 2.5% to 3.5% by resin weight, 2.2% to 3.8% by resin weight, although higher or lower concentrations may be used.

In some embodiments the ratio of crushed rock or aggregate to polyester resin mix in the admixture can range from 2:1 to 4:1, for example from 2.2:1 to 3.8:1, from 2.5:1 to 3.5:1, from 2.7:1 to 3.3:1, from 2.9:1 to 3.1:1. The consistency of the mixture of crushed rock or aggregate to polyester resin can depend on the amount of resin used. A more fluid-like admixture results when less crushed rock or aggregate is proportionally used. The ratio of crushed rock or aggregate to resin can affect the texture of the resulting stone cast, where higher ratios of crushed rock or aggregate can result in a more textured stone cast surface.

In some embodiments, artificial stone 100 can include a mechanism for securing the stone to an anchor point, such as a specific location in a garden. The exemplary embodiment of FIG. 1 includes a detachable stake 150 that has a pointed end 165 and an end that includes a threaded portion 160. Threaded portion 160 is matched to a receiving orifice 155 within the artificial stone 100, such that the stake 150 may be screwed in to the artificial stone 100. In some embodiments, a nut (not shown in FIG. 1) may be inserted into the thickness of the artificial stone 100 during the casting process (described below), said thickness being generally indicated by arrow 130, wherein the nut serves as threaded portion 160. Detachable stake 150 and the receiving orifice 155 can be composed of, for example, aluminum, steel, iron, or other similar materials. In some embodiments, it can be beneficial that stake 150 and the receiving orifice 155 be composed of rust-resistant material or treated with a rust inhibitor. In some embodiments the stake is galvanized and treated with a rust converter.

In some embodiments, a mechanism for securing the stone to an anchor point can include a stake or a nail without a threaded end. In some embodiments, the stake or nail can be inserted into the admixture during the casting process prior to the admixture curing and becoming hard. For example, a stake can be inserted into an admixture while it is still in slurry form and held in place by a brace, for example. As the admixture cures, the position of the stake can be locked into place permanently.

FIG. 1A is a photograph of an artificial stone and a mechanism for securing the stone to an anchor point, according to one embodiment. Receiving orifice 155 is a threaded collar of diameter about 5 mm to about 12 mm, for example 6 mm to 11 mm, from 7 mm to 10 mm, from 8 mm to 9 mm, for example from 5 mm to 6 mm and is configured to receive the threaded portion of stake 150. The stake and threaded portion can vary in diameter from about 5 mm to about 8 mm, for example, from bout 6 mm to about 7 mm. The length of the stake can be selected based upon its ultimate utility and the type of ground that it will be inserted into. In some embodiments the length of the stake is from about 4 inches to about 6 inches. In some embodiments the tip of the stake 150 is blunted for safety reasons.

Artificial stone 100 can be prepared, according to one embodiment, by casting, e.g., pouring an admixture of ingredients into a mold and allowing the admixture to cure into a solid form over a period of time. In some embodiments, the mold can be created from a model (e.g., a “positive model”) of a stone or rock. The model can contain as many features relating to the realism of the artificial stone as desired. The authenticity of the artificial rock can be influenced by features added to the model. For example, features such as roughness, texture, graininess, cracks, fissures, depressions, protrusions, and grain boundaries can be artistically added to the model.

The models can be made of materials such as wood, plaster, clay, and rock pieces, and can include visual and tactile features that will impart a realistic look and feel to the finished product. In one embodiment, the model can be a real stone or rock (i.e. a model that is not synthetic). In some embodiments, the model can further include additional details that can appear on the finished artificial stone 100 that are artificially imparted to the model. For example, a person preparing the model can add artificial fissures or cracks to the mold composition by hand, e.g., using artist's tools or similar instruments. In these embodiments, real rocks can be used to impart the details of their surface structure, including, for example, texture, morphology, and defects into the mold. In some embodiments, real rocks, i.e., those that have been formed in nature and contain features distinguishing it as so, such as being weathered, cracked, or sculpted under the influence of an external force, such as movement of water, can be incorporated into the model building process. In one embodiment, a suitable material for creation of the model can be plaster of Paris.

A mold of the model can be created from a material that forms a shell around the model. In one embodiment, two molds, each corresponding to one half or more of the finished artificial stone product can be made. The model can be treated with a surface chemical, such as a fine layer of wax prior to application of the molding material that allows separation from the model without sticking, cracking, or leaving chunks attached. Subsequently, the mold can be divided or cut, e.g., in half, using a border (i.e. a fold) or with a fine saw, thus producing two half-molds of the model; these molds can be used to produce an artificial rock as described below.

In some embodiments, an admixture of materials can be used to form an artificial stone similar to that shown in FIG. 1. The admixture can be composed of materials that impart a sense of realism to the artificial stone, such as texture, roughness, color, graininess, etc. In some embodiments, crushed, natural rock can be an ingredient of the admixture, which is formed as a slurry with an adhesive and can assume the shape of the mold. Admixture ingredients can be carefully added with the mixed polyester resin containing MEKP into the mold.

Adhesive agents in a liquid- or fluid-like state can be added to crushed rock to form an admixture, which can cure to a solid form after some period of time. Non-limiting examples of adhesives include cements, glues, polymers, and resins, for example. In some embodiments, hardening agents may be added to the admixture that increases the tensile strength of the resulting artificial stone or aids in, or accelerates a curing process.

In some embodiments, the admixture contains colorants or pigments that resemble the color of a naturally-occurring stone. When the admixture contains such colorants or pigments, the color of the resulting artificial stone can remain substantially homogeneous throughout the thickness of the cast, more closely resembling a real stone. Colorants or pigments can be water-, alcohol-, lacquer-, or acrylic-based in some embodiments.

In some embodiments, the thickness of the admixture ranges from about ⅛-inch to ¼-inch throughout, for example from about 5/16-inch to about 7/16-inch throughout. In some embodiments, the thickness of the admixture ranges from about ¼-inch to ½-inch throughout, for example, from about ⅜-inch to about ⅝-inch.

In some embodiments, reinforcing material can be applied to the admixture. In one embodiment, natural or synthetic fibers may be employed for this purpose. For example, fiberglass can be added to the admixture directly, or can be added to a portion of the inner-shell of an artificial stone and held in place by an adhesive. The latter embodiment can occur after the stone cast has dried at least partially and is able to maintain its shape in the mold. In some embodiments, the inner-wall of an artificial stone cast can be packed with a thickness of fiberglass; the fiberglass can then be painted over with resin, such as a resin that may have been used as an ingredient in the admixture. The resin, once cured, can form a strong layer when incorporated with the fiberglass thickness, and can thereby add to the tensile strength of the artificial stone.

In some embodiments, the reinforcing material thickness is about 1/32-inch to ¼-inch, for example, from about 1/16-inch to about 3/16-inch, from about ⅛-inch to about 3/16-inch. In some embodiments, the reinforcing material is fiberglass. In some embodiments the mesh number or “thickness number” of the fiberglass can range from about #300 to about #450, for example, from about #325 to about #425, from about #350 to about #400, from about #375 to about #400. In some embodiments fiberglass chop strands can also be used. In these embodiments the fiberglass chop strands can preferably range from about ¼-inch to about 2 inches, for example, from about ½-inch to about 1.75-inches, from about ¾-inch to about 1.5 inches, from about 1 inch to about 1.25 inches, in length.

In embodiments where two molds are used to produce one half of the finished product, a fastening mechanism 170 can be utilized that aids in joining the two halves together. Fastening mechanism 170 can include, for example, a dowel that protrudes from the thickness 130 of the shell, perpendicular to a cross-section of the shell, in one of the artificial stone halves. In some embodiments, the dowel can be made of wood. In other embodiments, the dowel can be made of metal or synthetic materials, including polymers, or can be a protrusion of formed from the admixture or the admixture resin. The other half of the artificial stone 100 (not shown in FIG. 1) can include, for example, a recess in the admixture that receives the dowel and is positioned such that the two halves of the stone cast are joined together with a minimum amount of discontinuity in the resulting seam.

In these embodiments, an adhesive can be applied to the surface of the cross-section of the thickness 130 to bond the two halves, and the dowels can provide guidance for the joining process. The dowels may also provide mechanical strength that resists shear forces that may be applied to the artificial stone 100 during the course of its lifetime.

While the embodiment of FIG. 1 shows two fastening devices 170, it will be understood that as many fastening devices 170 as necessary to mate portions of an artificial stone 100 can be employed. Likewise, it will also be understood that an artificial stone 100 can be formed from more than two molds; i.e., larger, more artificial stones 100 can be formed from multiple sections and joined together by a variety of methods, some of which have been presented herein.

In embodiments where mechanical structures are present in the thickness 130 of the cross-section of the artificial stone shell, such structures can be incorporated before the admixture cures. For example, elements of mechanical fastener 170 can be inserted into the admixture and held in a desired orientation by stabilization devices prior to the curing of the admixture. In one embodiment, a dowel can be partially inserted into the admixture and held such that its long axis is perpendicular to a cross-section of the artificial stone 100 by external supports such a brace or component of the mold frame (not shown). A corresponding recess can be created in portion of the artificial stone.

Integral parts of an unassembled artificial stone 100 (e.g., each half) can be joined by applying an adhesive to each side and mating them together. In some embodiments the adhesive is a resin. In some embodiments the resin can be applied to the cross-section of the thickness (i.e., the thickness generally depicted by arrow 130) across its surface. In some embodiments, a reinforcing material, such as fiberglass, can be applied to the inner shell of the artificial rock such that it protrudes slightly ahead of the surface to which the resin will be applied. Adhesive can be applied to both the stone cast, and the reinforcing material. The pieces of the stone cast can then be integrally joined by applying pressure to each piece in, for example, opposing directions.

In some embodiments, the mold can include a device for applying pressure to be applied during the mating process of the stone cast pieces. In some embodiments, the mold can include mated flanges; for example, each side of a mold can include a flange and a partner flange, such that when the flange and the partner flange are aligned, the seam of the resulting artificial stone 100 is preferentially visually minimized. A fastening device can be inserted through the flange and the partner flange to draw the pieces together. In some embodiments, the fastening device can be a nut and bolt combination that is used to secure pieces of the artificial rock to one another.

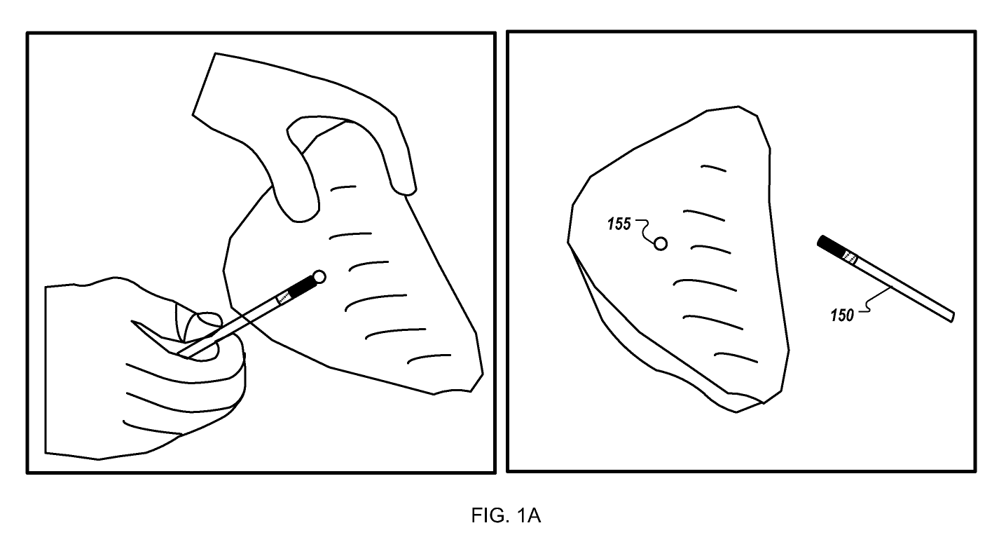

FIG. 2 illustrates some of the shapes, colors, and sizes of artificial rocks created by embodiments of the methods disclosed herein.

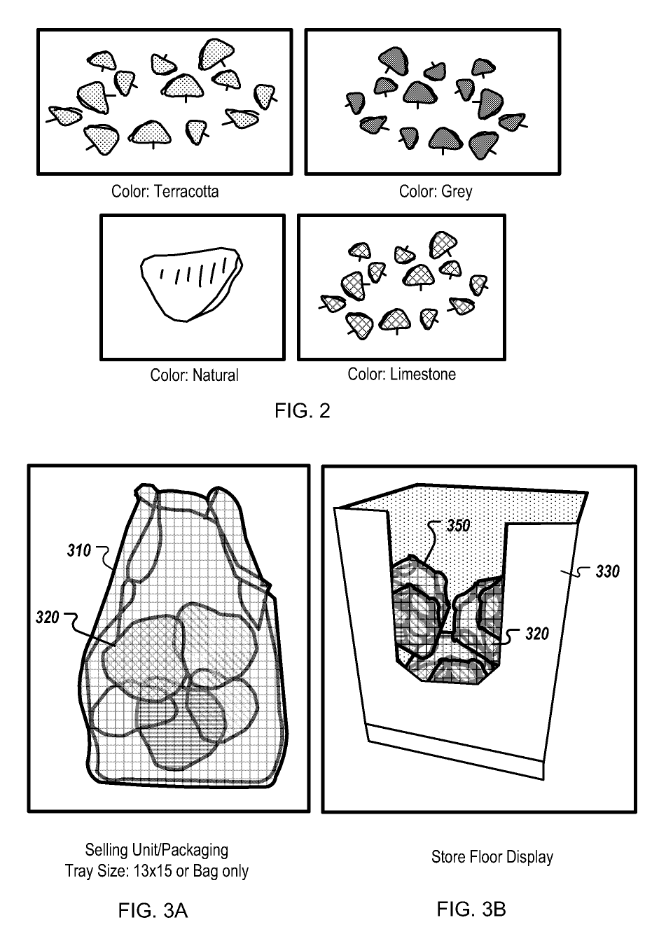

Artificial stones of the type described herein can be packaged for easy transport. FIGS. 3A and 3B illustrate a method of transporting a collection of artificial stones, according to one embodiment. Because they are lightweight, the stones 320 may be carried together in a bag or mesh net 310, where the securing mechanism, e.g., the stakes (150 in FIG. 1, not shown in FIG. 3A or 3B) may be separately packaged for safety reasons. Similarly, as shown in FIG. 3B, artificial stones 320 may be packaged in bulk quantities. Individual sale units 350, including collections of rocks, can be made available for consumers to pick and choose their favorites from a store display container 330.

### EXAMPLE

The following example is provided to illustrate various embodiments that can be used to form an artificial stone 100 according to the concepts provided above and is non-limiting with respect to the claims.

Model preparation process. A positive model was created that contained desired attributes or characteristics of real stones and rocks found in nature. The model was formed using wood, plaster, and clay components and contained characteristic details of naturally-occurring rocks and stones, such as surface roughness, discontinuities, protrusions, recesses, cracks, fissures, etc. The model preparation process can incorporates artistic qualities that are better left to the interpretation of the artist preparing the model rather than attempting to describe them here. However, it will be understood that many techniques and supplies are available to artists that will allow them to accurately reproduce the attributes and fine details of rocks and stones found in nature.

Mold preparation process. A release wax was applied to the model to allow the mold to be removed easily once cured. The release wax was sprayed on, but may also be applied manually, such as by brushing techniques. A polyester mix, composed of unsaturated polyester resin, cobalt, and styrene, was mixed with a hardener, methyl ethyl ketone peroxide (MEKP) and applied to the model. Shredded fiberglass mats were placed on the exterior of the model and held in place by brushing on a layer of polyester/hardener mixture, with pressure, so that the mixture fully penetrated the fiberglass. The polyester mix with hardener was applied to the entire exterior of the mold on top of the fiberglass until the fiberglass layer could no longer hold additional polyester mix. Multiple layers of fiberglass may be applied in this fashion. The mold was then left to cure for 16-24 hours.

After the mold had cured, it was split substantially in half using a fine saw. The mold was checked for flaws, and if found, they were easily removed by sanding or buffing. The mold was washed to remove remaining wax, residue, and other mold ingredients, such as sand or pebbles which can be added for surface roughness.

Stone casting process. The artificial stone, e.g., stone 100 in FIG. 1 was created by first applying a small amount of wax to the mold to allow for easy removal of the stone cast, then pouring an amount of an admixture containing crushed or pulverized limestone, polyester resin (as described above), hardener, and colorant into the mold. The admixture was made to reach all areas of the mold (in this case one-half of the artificial stone) by inserting a bowl into the mold and forcing the admixture up the sides of the mold, to the top. Two bolts were supported in the as-yet uncured admixture in the center of the thickness (corresponding to thickness 130 in FIG. 1) such that their long axis extended normal to the surface of the cross-section of the admixture thickness. On the other half of the artificial stone, two nuts were inserted into the admixture with a small amount of wax disposed within the threaded portion of the nut to prevent admixture from entering therein. In addition, a small dowel was inserted into the admixture below the nut, in such a way as to allow room for the bolt from the other half of the artificial stone to be inserted.

One of the two stone casts was fitted with a securing mechanism used to keep the artificial stone in place during use. A small threaded collar, having wax inserted therein to prevent admixture from entering the threaded portion, was inserted into the admixture, such that one end of the collar protruded from the exterior surface of the artificial rock. This collar served as the anchor mechanism for a threaded stake that was subsequently inserted therein by screwing (see FIG. 1).

The stone casts were allowed to cure for 30 minutes to 2 hours, after which time the casts were removed from the mold, washed, and sanded in areas that contained sharp protrusions or other unwanted elements. At this stage, the stone casts already exhibited a color corresponding to the colorants added in the previous steps. However, to produce additional realism, the stone casts can be painted on the exterior in certain areas if so desired. A layer of fiberglass was applied to the interior of each stone cast shell by applying resin to the interior surface. The fiberglass was shredded by hand and manually inserted into the stone casts filling as many voids and valleys as possible. A coating of resin was then applied to the fiberglass to fix it in position. The fiberglass extended beyond the top of the stone cast (i.e., the fiberglass protruded above where the two halves would be joined). The stone cast halves were joined together by applying resin to the surface of the cross-section of the thickness and the protruding fiberglass. The two halves were joined together by applying pressure to each half in opposing directions, and allowing the joining resin to cure. Any small imperfections were then sanded down. A layer of colorant was applied, or, in some cases, colorant was added to select areas of the artificial stone to produce a desired level of realism, or to mimic a certain type of rock.

In some embodiments, the artificial stones described above can be used in landscaping applications. Rocks and stones are a popular way to visually accentuate various components of landscapes, and they can add functionality as well. The above-described artificial stones can be substantially lighter than a corresponding real rocks or stones, i.e., those occurring naturally, because they are hollow and composed of materials that are generally lighter than real, solid rock. Because of their lightweight nature, artificial stones of the types described herein can be moved about while reducing the likelihood of necessitating heavy machinery or overly-laborious effort.

One implementation of the artificial rocks disclosed above can be to form attractive landscape edging. Because the artificial rocks are generally lightweight, i.e., they are generally lighter than a corresponding naturally-occurring rock of the same dimension, a person can change readily a design of their landscape edging. Artificial stones of the types described herein can be immobilized by inserting an attached stake into the ground at a desired location. Such immobilization methods reduce, e.g., the likelihood of the artificial stone being blown from its desired position by strong winds or accidentally rolling down a hill. Because they so closely resemble naturally-occurring rocks and stones on the exterior, they can be placed in conspicuous places such as an entryway to a front door.

In some embodiments, the two piece construction allows for more compact transport and alleviates safety concerns/issues associated with fixed protruding stakes.

In some cases, people prefer to use landscaping consisting of elements that are native or indigenous to their local surroundings. For example, one may use interior or exterior decorations made from trees found in their region. On the other hand, some people enjoy displaying pieces, such as artwork or décor from foreign sources, such as places where rocks are formed as a result of an earthly process that is exclusive to a remote location. Volcanic rocks are one such example. Because the artificial stones described herein can replicate practically any type of naturally rock or stone, one can create a collection of faux stones that mimic those found in remote geographic areas around the world, without incurring a potentially substantial cost to ship real such stones.

Artificial stones of the type described herein can be made to any shape or size, thus, they allow for ‘freeform’ landscaping designs that incorporate large and small artificial stones that can make tight turns and ‘hug’ curves of small radius.

In some selected embodiments, the stones have a size of about four inches to about 20 inches, for example, from between 6 inches to 18 inches, from about 8 inches to 16 inches, from about 10 inches to 14 inches, in circumference. In some selected embodiments, the stones can weigh between about 0.3 pounds to about 14 pounds, for example, between about 0.5 pounds and 0.8 pounds, from about 0.5 pounds to about 1 pound, from about 1 pound to about 12 pounds, from about 3 pounds to about 9 pounds, from about 5 pounds to about 6 pounds, from about 3 pounds to about 4 pounds. Table 1 shows a series of artificial rocks produced by processes described herein and their corresponding volumes and weights.

TABLE 1
Artificial rocks with corresponding sizes and weights.

| | | |
|---|---|---|
| Name | Size dimensions | Weight |

| | | | |
|---|---|---|---|
| Rock 1 | 6 × 6 × 3″ | inches | 450 grams |
| Rock 2 | 9.75 × 6.25 × 4″ | inches | 650 grams |
| Rock 3 | 12.625 × 5.50 × 4.50″ | inches | 720 grams |
| Rock 4 | 8.25 × 6.25 × 3″ | inches | 500 grams |
| Rock 5 | 12 × 6 × 4.25″ | inches | 700 grams |
| Rock 6 | 9.75 × 4.5 × 4.75″ | inches | 600 grams |
| Rock 7 | 12 × 6 × 4.5″ | inches | 720 grams |
| Rock 8 | 9.50 × 6.25 × 4.25″ | inches | 660 grams |
| Rock 9 | 9.50 × 5 × 4.50″ | inches | 600 grams |
| Rock 10 | 6.75 × 6 × 4″ | inches | 650 grams |
| Rock 11 | 7.25 × 5.25 × 3.5″ | inches | 500 grams |
| Rock 12 | 6.75 × 5 × 4″ | inches | 450 grams |
| Rock 13 | 7.50 × 5.50 × 3″ | inches | 500 grams |
| Rock 14 | 6.625 × 4 × 3.50″ | inches | 400 grams |

In some embodiments, a coat of protective material can be applied to a finished artificial stone to prevent it from becoming nicked or scratched during the course of its lifetime. As an example, a coat of low-gloss polyurethane may be applied to the exterior of the artificial stone.

In some embodiments, a kit may be supplied to a consumer, i.e., one who purchases an artificial rock, containing materials for repairing an artificial stone that has become damaged. In one embodiment, a kit may include any or all of the ingredients that were used in the stone cast admixture. In some embodiments the admixture contained in a repair kit is colored to match the color of the artificial stone.

In some embodiments, mechanical attaching devices can be used to link one artificial rock to another. For example, a hook-and-eye system may be integrated into the artificial rocks, whereby one artificial rock has a hook embedded in the admixture, similar to the process used for embedding a stake or dowel, and the other artificial rock has a corresponding eye. A user may “link” a series of artificial rocks together to provide additional protection from unwanted movement.

In some embodiments, attachment mechanisms can be integrated into the artificial rocks that aid in displaying the rocks for a specific purpose. For example, an interior decorator may wish to produce a contemporary room design by suspending artificial rocks from a ceiling, giving the impression that large (real) rocks are “floating” in space, which can be accomplished using the artificial stones described herein due to their relatively light weight. In embodiments such as these, means for attaching “invisible” string, such as high-strength fishing line, can be adapted to the artificial rock. In some embodiments, a bolt can be fashioned into the admixture that protrudes from the surface of the artificial rock before it cures. In some embodiments, an eye-bolt or an eye-lag can be screwed into a threaded collar present in the artificial rock in a similar manner as for the stake which secures its position in the ground.

In some embodiments, the artificial rocks can be solid instead of hollow, as has been described herein. The process of making a solid artificial rock is principally no different than that has been explained for hollow rocks. Solid artificial rocks may be used when structural stability is required or when extra weight is desired, such as if a stake alone is not suitable to hold the artificial rock in place.

A number of illustrative embodiments have been described. Nevertheless, it will be understood that various modifications may be made without departing from the spirit and scope of the various embodiments presented herein. For example, throughout the specification, the term “stone” is synonymous with “rock” and other types of naturally-occurring formation of similar constitution. Artificial stones can be utilized in outdoor as well as indoor applications. Artificial stones can be incorporated into structural building components are not limited to stand-alone decorations or accents. For example, the artificial rocks disclosed herein can be used in relatively lightweight wall construction, where the artificial rocks give the impression that real rocks make up part of the wall composition. Accordingly, other embodiments are within the scope of the following claims.

What is claimed is:

1. An imitation stone, comprising:
a stone cast, comprising visual and tactile qualities that closely match features of real rocks found in nature, wherein the stone cast comprises real crushed stones or rocks, held in a preformed shape by a binding agent, wherein the binding agent comprises a colorant; and
an anchor for securing the imitation stone to a selected location.
